(19) United States
(12) Patent Application Publication
(10) Pub. No.: US 2005/0046509 A1
(43) Pub. Date: Mar. 3, 2005

(54) High-frequency signal suppresser

(75) Inventor: Chun-Hsiung Chen, Hsinchu (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: Holtek Semiconductor Inc., Hsinchu (TW)

(21) Appl. No.: 10/781,193

(22) Filed: Feb. 18, 2004

(30) Foreign Application Priority Data
Aug. 25, 2003 (TW) 092123326

(51) Int. Cl. H04B 3/28

(52) U.S. Cl. 333/12; 333/20

(57) ABSTRACT

An high-frequency signal suppresser includes a resister, a first capacitor, a second capacitor, and a shaping circuit. A high-frequency signal inputted from the input terminal of the high-frequency signal suppresser is filtered by the resister, the first capacitor, and the second capacitor, and then shaped by the shaping circuit so as to generate a logic signal at the output terminal of the high-frequency signal suppresser.

### FIELD OF THE INVENTION

The present invention relates to a high-frequency signal suppresser and more specifically to a high-frequency signal suppresser for suppressing electromagnetic interference (EMI).

### BACKGROUND OF THE INVENTION

Electromagnetic compatibility of electronic devices is generally the key performance to design and producing process.

The so-called Electromagnetic compatibility (EMC) means that equipments or systems are able to be adapted to the demands of normal functioning in an electromagnetic environment and generate no signals of electromagnetic interference, which are intolerable for other equipments or systems in the same environment. That is to say, the performance of EMC is required in two aspects, electromagnetic interference (EMI) and electromagnetic susceptibility (EMS). The former demands that during normal operation, only certain amount of signals of electromagnetic interference can be generated in the environment where the equipments exist, while the latter demands that the equipments must have considerably enough competence of isolating electromagnetic interference in the environment where they are located.

The reasons for the interference problems of electromagnetic compatibility are usually the interference of static electricity, the interference of electromagnetic waves, and the interference of power supply. The influence of these abnormal phenomenons is to that a high-frequency signal might induct or be input into the electronic circuit of the electronic device during normal operation. This leads to malfunction or structural destruction of electronic devices.

A conventional resolution for the interference of high-frequency signal is to implement an auxiliary protecting circuit around the circuit of the electronic device so that the electromagnetic susceptibility of the electronic device will be raised. The protecting circuits, whose implementation depends on different design of factories, basically are additional resistors or capacitors, or even expensive noise-rejected capacitors. However, not only the difficulty in circuit design is increased, but also the product yield is seriously affected. Besides, the cost and the product price will be unavoidably increased, which eventually damages the competitiveness of the company.

It is therefore attempted by the applicant to deal with the above situation encountered in the prior art.

### SUMMARY OF THE INVENTION

It is the main object of the present invention to provide a simple high-frequency suppresser for shielding electronic devices from electromagnetic interference.

It is another object of the present invention to provide a simple high-frequency suppresser for reducing the interference of high-frequency signal and strengthening electromagnetic susceptibility (EMS) of electronic devices.

According to one aspect of the present invention, the high-frequency signal suppresser, includes a resister having a first terminal serving as an input terminal of the high-frequency signal suppresser, a first capacitor having a first terminal electrically connected to a high voltage source and a second terminal electrically connected to a second terminal of the resister, a second capacitor having a first terminal electrically connected to the first capacitor and the resister, and a second terminal electrically connected to a low voltage source and a shaping circuit having an input terminal electrically connected to the first capacitor, the resister, and the second capacitor, and an output terminal serving as an output terminal of the high-frequency signal suppresser, wherein a high-frequency signal inputted from the input terminal of the high-frequency signal suppresser is filtered by the resister, the first capacitor, and the second capacitor, and then shaped by the shaping circuit so as to generate a logic signal at the output terminal of the high-frequency signal suppresser.

Preferably, the resister is one selected from a group consisting of an output resistance of a complementary metal-oxide-semiconductor, a metal-oxide-semiconductor resister, a transmission gate, a poly-Si, and a quantum well.

Preferably, the first capacitor and the second capacitor are one of an input parasitic capacitor of the shaping circuit and a metal-oxide-semiconductor capacitor.

Preferably, the shaping circuit is one selected from a group consisting of a SCHMITT trigger circuit, a logic gate, and a comparator.

According to another aspect of the present invention, the high-frequency signal suppresser, includes a filter having an input terminal and a shaping circuit having an output terminal and electrically connected in series with the filter, wherein a high-frequency signal inputted from the input terminal is filtered by the filter and then shaped by the shaping circuit so as to generate a logic signal at the output terminal.

Preferably, the filter is a low pass filter.

Preferably, the filter includes a resister having a first terminal serving as the input terminal and a second terminal electrically connected to the shaping circuit, a first capacitor having a first terminal electrically connected to a high voltage source and a second terminal electrically connected to the resister and the shaping circuit; and a second capacitor having a first terminal electrically connected to the first capacitor, the resister, and the shaping circuit, and a second terminal electrically connected to a low voltage source.

Preferably, the resister is one selected from a group consisting of an output resistance of a complementary metal-oxide-semiconductor, a metal-oxide-semiconductor resister, a transmission gate, a poly-Si, and a quantum well.

Preferably, the first capacitor and the second capacitor are one of an input parasitic capacitor of the shaping circuit and a metal-oxide-semiconductor capacitor.

Preferably, the shaping circuit is one selected from a group consisting of a SCHMITT trigger circuit, a logic gate, and a comparator.

The above objects and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 is a schematic diagram of a high-frequency suppresser in accordance with a preferred embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

The present invention provides a high-frequency suppresser with particular electric implementation for solving problems of electromagnetic interference. The high-frequency suppresser is electrically connected to the clock signal terminals, the fringe trigger terminals, or the input and output terminals of the electronic systems to filter and suppress the external interference signals. Besides, since external interference signals may also interfere the power supply of the electronic systems, which results in the drift of the logic conversion point and the occurrence of high-frequency noise, the electronic systems might malfunction. Therefore, according to a preferred embodiment of the present invention, the high-frequency suppresser also serves as a strong defense against the interference generated from the power supply so as to overcome the interference problems of high-frequency signals completely.

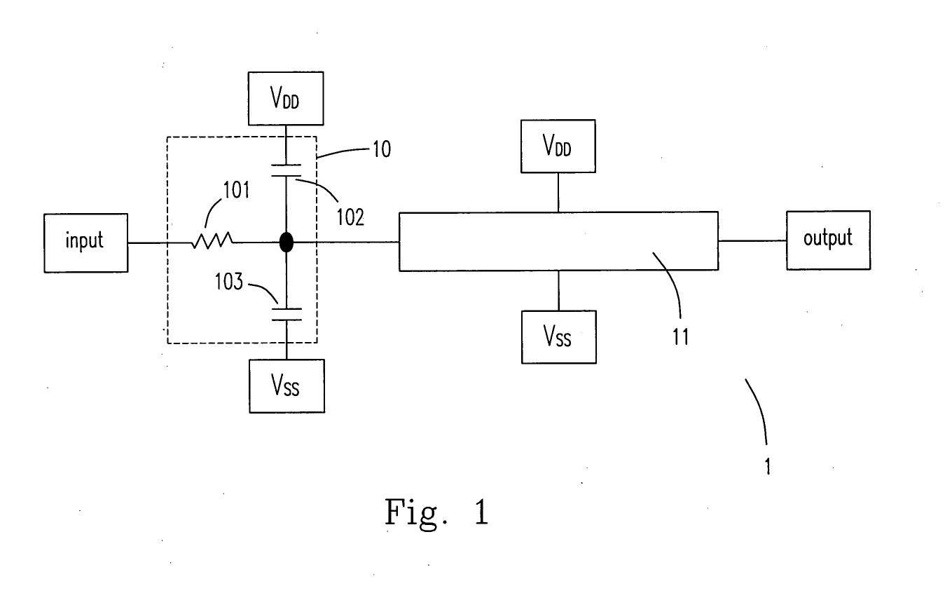

Please refer to FIG. 1, which is a schematic diagram of a high-frequency suppresser in accordance with a preferred embodiment of the present invention. A high-frequency suppresser 1 includes the low-pass filter 10 and the shaping circuit 11. The low-pass filter 10 and the shaping circuit 11 are electrically connected in series. A high-frequency signal inputted from the input terminal of the high-frequency suppresser 1 is filtered by the low-pass filter 10 and then shaped by the shaping circuit 11 so as to generate a logic signal at the output terminal of the high-frequency suppresser 1.

In the preferred embodiment shown in FIG. 1, the elements of the low-pass filter 10 includes the resister 101 and two capacitors 102 and 103, as circled by dotted lines. The input terminal of the resister 101 is the input terminal of the high-frequency suppresser 1. The output terminal of the resister 101 is electrically connected to the capacitors 102 and 103 and the input terminal of the shaping circuit 11. In addition, the capacitor 102 is electrically connected to the high voltage source V_{DD}. The capacitor 103 is electrically connected to the low voltage source V_{SS}. Also the shaping circuit 11 is electrically connected to the high voltage source V_{DD} and the low voltage source V_{SS}, and then driven by the voltage difference between the two sources.

The preferred embodiment exemplifies the principle of the invention and is not being considered a limitation to the broader aspects of the invention. For instance, the resister 101 can be the parasitic output resistance of a complementary metal-oxide-semiconductor, a metal-oxide-semiconductor resister, a transmission gate, a poly-Si, or a quantum well. For the shaping circuit 11, a SCHMITT trigger circuit would be a better choice comparing with a logic gate or a comparator. Both the logic gate and the comparator are feasible but not satisfactory enough. Similarly, for the capacitors 102 and 103, not only the input parasitic capacitor of the shaping circuit 11 but also a metal-oxide-semiconductor capacitor is suitable. Particularly, the inconsistency between the capacitance of the capacitors 102 and 103 is permitted, as long as the respective variation ratios of the comparing point to the high voltage V_{DD} are similar.

With reference to the problems of both signal interference and power supply interference, the invention is able to solve them effectively as being described in detail herein below. Here R represents the resistance of the resister 101, while C1 and C2 represent the capacitance of the capacitors 102 and 103 respectively.

(1) For the high-frequency clock signal and the high-frequency input signal of systems:

In the beginning, a high-frequency signal is inputted from the input terminal of the high-frequency suppresser 1 and filtered by the low-pass filter 10, wherein the time constant is R*(C1+C2). After being shaped by the shaping circuit 11, a logic signal is generated at the output terminal of the high-frequency suppresser 1. The time constant R*(C1+C2) and the comparing point of the shaping circuit 11 are utilized to design the suppressing point of high-frequency band.

(2) For interference of power supply:

With the capacitor 102 and 103 electrically connected to the high and low voltage sources V_{DD} and V_{SS} respectively, the noises of power supply inputted from the input terminal of the high-frequency suppresser 1 are distributed to the input terminal of the shaping circuit 11 by the low-pass filter 10 in a very short time. The signal at the input terminal of the shaping circuit 11 drifts with the logic conversion point simultaneously so as to prevent the output signal of the logic conversion point of the shaping circuit 11 from being disturbed by high-frequency noises of power supply. Similarly, a high-frequency signal is inputted from the input terminal of the high-frequency suppresser 1 and filtered by the low-pass filter 10, wherein the time constant is R*(C1+C2). After being shaped by the shaping circuit 11, a logic signal is generated at the output terminal of the high-frequency suppresser 1. The time constant R*(C1+C2) and the comparing point of the shaping circuit 11 are utilized to design the suppressing point of high-frequency band.

The invention is to strengthen the electromagnetic compatibility of electronic devices by the implementation of simple circuits. With low cost and tremendous effect, the high-frequency signal suppresser provided in the invention protects electronic devices from electromagnetic interference by filtering high-frequency signals from power supply, clock high-frequency signals, and external high-frequency signals. The high-frequency signal suppresser also enhances the operation stability and electromagnetic susceptibility of electronic devices so as to decrease the need for auxiliary protecting circuits as well as the difficulty in circuit design. The invention has the advantages of low cost, excellent performance, and superior competitiveness.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

1. A high-frequency signal suppresser, comprising:
a resister having a first terminal serving as an input terminal of said high-frequency signal suppresser;
a first capacitor having a first terminal electrically connected to a high voltage source and a second terminal electrically connected to a second terminal of said resister;
a second capacitor having a first terminal electrically connected to said first capacitor and said resister, and a second terminal electrically connected to a low voltage source; and
a shaping circuit having an input terminal electrically connected to said first capacitor, said resister, and said second capacitor, and an output terminal serving as an output terminal of said high-frequency signal suppresser;
wherein a high-frequency signal inputted from said input terminal of said high-frequency signal suppresser is filtered by said resister, said first capacitor, and said second capacitor, and then shaped by said shaping circuit so as to generate a logic signal at said output terminal of said high-frequency signal suppresser.

2. The high-frequency signal suppresser according to claim 1, wherein said resister is one selected from a group consisting of an output resistance of a complementary metal-oxide-semiconductor, a metal-oxide-semiconductor resister, a transmission gate, a poly-Si, and a quantum well.

3. The high-frequency signal suppresser according to claim 1, wherein said first capacitor and said second capacitor are one of an input parasitic capacitor of said shaping circuit and a metal-oxide-semiconductor capacitor.

4. The high-frequency signal suppresser according to claim 1, wherein said shaping circuit is one selected from a group consisting of a SCHMITT trigger circuit, a logic gate, and a comparator.

5. A high-frequency signal suppresser, comprising:
a filter having an input terminal; and
a shaping circuit having an output terminal and electrically connected in series with said filter;
wherein a high-frequency signal inputted from said input terminal is filtered by said filter and then shaped by said shaping circuit so as to generate a logic signal at said output terminal.

6. The high-frequency signal suppresser according to claim 5, wherein said filter is a low pass filter.

7. The high-frequency signal suppresser according to claim 5, wherein said filter comprises:
a resister having a first terminal serving as said input terminal and a second terminal electrically connected to said shaping circuit;
a first capacitor having a first terminal electrically connected to a high voltage source and a second terminal electrically connected to said resister and said shaping circuit; and
a second capacitor having a first terminal electrically connected to said first capacitor, said resister, and said shaping circuit, and a second terminal electrically connected to a low voltage source.

8. The high-frequency signal suppresser according to claim 7, wherein said resister is one selected from a group consisting of an output resistance of a complementary metal-oxide-semiconductor, a metal-oxide-semiconductor resister, a transmission gate, a poly-Si, and a quantum well.

9. The high-frequency signal suppresser according to claim 7, wherein said first capacitor and said second capacitor are one of an input parasitic capacitor of said shaping circuit and a metal-oxide-semiconductor capacitor.

10. The high-frequency signal suppresser according to claim 5, wherein said shaping circuit is one selected from a group consisting of a SCHMITT trigger circuit, a logic gate, and a comparator.
